(19) United States
(12) Patent Application Publication
(10) Pub. No.: US 2011/0078002 A1
(43) Pub. Date: Mar. 31, 2011

(54) ALTERNATIVE ADVERTISEMENT PLACEMENT IN RECORDED CONTENT STREAMS

(75) Inventors: Patrick J. Leary, Horsham, PA (US); Christopher S. Del Sordo, Souderton, PA (US); Yeqing Wang, Horsham, PA (US)

(73) Assignee: GENERAL INSTRUMENT CORPORATION, Horsham, PA (US)

(21) Appl. No.: 12/569,161

(22) Filed: Sep. 29, 2009

(51) Int. Cl. G06Q 30/00

(52) U.S. Cl. 705/14.4

(57) ABSTRACT

A set top box includes a tuner for receiving a switched digital video (SDV) stream from an SDV source, in which the SDV stream contains content and a default advertisement. The set top box also includes a memory for storing the SDV stream and a controller for generating and outputting an ad catalog to at least one of an ad server and an SDV manager, in which the ad catalog contains information useable by the ad server in identifying one or more alternative advertisements to be played by the set top box during play of the SDV stream in place of the default advertisement, and in which the controller is configured to receive the one or more alternative advertisements and to replace the default advertisement in the SDV stream.

### BACKGROUND

Switched digital video (SDV) refers to an arrangement in which broadcast channels are only switched onto the network when they are requested by one or more subscribers, thereby allowing system operators to save bandwidth over their distribution network. Thus, a SDV channel is only available when requested by one or more authorized subscribers. In contrast, in conventional cable or satellite broadcast systems, every broadcast channel is always available to all authorized subscribers. Also, unlike video on-demand, which switches a unicast interactive program to a user, SDV switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The SDV subscribers will thus often share the same resource managers and underlying resources with other on demand services.

One way to support switched digital video is to utilize a SDV Manager to manage broadcast sessions. For each channel change, the subscriber will set up a broadcast session with the SDV Manager, which will determine if the requested channel is already being sent to the corresponding service group to which the subscriber belongs. The subscriber will be assigned to join the existing broadcast session if the requested channel is available at the service group or assigned to a new broadcast session if the requested channel is not available at the service group. The SDV Manager will negotiate with the edge devices to allocate resources required for the session. The edge device (e.g., a digital modulator such as a QAM modulator) needs to dynamically retrieve the MPEG single program transport stream that carries the requested broadcast program (likely via IP multicast) and generate the MPEG multiple program transport stream. As part of the session setup response message, the video tuning parameters such as frequency and MPEG program number are sent back to the subscriber to access the requested broadcast channel.

In addition, addressable advertising has been proposed to target a specific group of subscribers based on the demographics of the subscriber household through switching operations performed at the subscribers' set top boxes (STBs). Operators of cable systems are interested in delivering addressable advertising as a way to increase revenue received from local advertising and to stop the flow of advertising dollars from television to other media, such as the Internet.

Conventional methods of providing addressable advertising typically require changes to the set top code, which is often costly and time consuming due to the variety of STBs deployed in a given system. Some STBs are typically incapable of this form of addressable advertising due to hardware limitations, such as lack of code space, slow tuning, and lack of processing power. Additionally, the ad streams containing the addressable advertising use RF bandwidth, which is in limited supply. The problem is magnified when high definition ad streams are streamed to the STBs.

### SUMMARY

Disclosed herein is a set top box that includes a tuner for receiving a content stream from a content source, in which the content stream contains content and a default advertisement. The set top box also includes a memory for storing the content stream and a controller for generating and outputting an ad catalog to at least one of an ad server and an SDV manager, in which the ad catalog contains information useable by the ad server in identifying one or more alternative advertisements to be played by the set top box during play of the content stream stored in the memory in place of the default advertisement, and in which the controller is configured to receive the one or more alternative advertisements and to replace the default advertisement in the stored content stream with the one or more alternative advertisements during play of the stored content stream.

Also disclosed herein is a method of playing an alternative advertisement in a set top box (STB). In the method, a content stream containing content and a default advertisement from a content source is stored, an ad catalog containing information useable by an ad server in identifying one or more alternative advertisements to be played by the set top box in place of the default advertisement contained in the stored content stream is generated and outputted to at least one of the ad server and an SDV manager, in which the ad server is configured to identify one or more alternative advertisements to replace the stored default advertisement. In addition, the identified one or more alternative advertisements are received and the default advertisement is replaced with the identified one or more alternative advertisements during playback of the stored content stream.

Still further disclosed is a computer readable storage medium on which is embedded one or more computer programs implementing the above-disclosed method of playing an alternative advertisement in a set top box (STB), said one or more computer programs comprising a set of instructions for: storing a content stream from a content source, said content stream containing content and a default advertisement; generating an ad catalog containing information useable by an ad server in identifying one or more alternative advertisements to be played by the set top box in place of a default advertisement contained in stored content stream; outputting the ad catalog to at least one of the ad server and an SDV manager, wherein the ad server is configured to identify one or more alternative advertisements to replace the stored default advertisement; receiving the identified one or more alternative advertisements; and replacing the default advertisement with the identified one or more alternative advertisements during playback of the stored content stream.

Through implementation of the set top box and method disclosed herein, stale or otherwise old advertisements that have been recorded to a digital video recorder (DVR) of the set top box along with content may be replaced with fresher or otherwise newer advertisements. In one regard therefore, the same content stored on the DVR may be played back at different times with different alternative advertisements replacing the default advertisements each time the stored content is played.

### BRIEF DESCRIPTION OF THE DRAWINGS

Embodiments are illustrated by way of example and not limited in the following figure(s), in which like numerals indicate like elements, in which:

FIG. 1 illustrates a block diagram of content delivery system, according to an embodiment of the invention;

FIG. 2 illustrates a block diagram of content delivery system, according to another embodiment of the invention;

FIG. 3 illustrates a block diagram of a method of playing an alternative advertisement in a set top box, according to an embodiment of the invention;

FIG. 4 shows a block diagram of a computing apparatus configured to implement or execute one or more of the processes depicted in FIGS. 1-3, according to an embodiment of the invention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures are not described in detail so as not to unnecessarily obscure the description of the embodiments.

The term “content stream,” as used herein, refers to a broadcast stream delivered over a content network. The content stream may contain program segments and default advertisements.

The term “advertisement,” as used herein, refers to a broadcast public notice, for instance, that is directed to particular goods or services. A “default advertisement” refers to an advertisement that is originally supplied in the broadcast content stream. An “alternative advertisement” refers to an advertisement that is inserted in place of the default advertisement, such as, a targeted advertisement.

The term “ad pod,” as used herein, refers to a commercial break in a broadcast content stream. An ad pod is comprised of at least one space for an advertisement to be broadcast during the commercial break. In addition, an ad pod may have sufficient space for multiple consecutive advertisements to be inserted into the content stream.

The term “ad opportunity,” as used herein, refers to a point in the content stream at which alternative advertisements, such as advertisements targeted to particular individuals or groups of individuals, may be inserted in place of the default advertisements in the content stream.

The term “ad stream,” as used herein, refers to a stream containing one or more of the alternative advertisements that may be inserted into the content stream. The ad stream may be a multicast stream or a unicast stream.

The term “ad marker,” as used herein, refers to a marker embedded within the content stream that indicates that an ad opportunity is soon approaching. The ad marker may also indicate the duration of the upcoming ad opportunity.

The term “ad request,” as used herein, refers to a signal communicated to an ad server requesting that an alternative advertisement be located for insertion into the content stream at an ad opportunity.

The term “ad instruction,” as used herein, refers to a signal communicated to an SDV manager to tune to a particular location in the spectrum in order to locate a particular alternative advertisement.

The term “ad insert,” as used herein, refers to the supply of data containing one or more alternative advertisements to a set top box (STB).

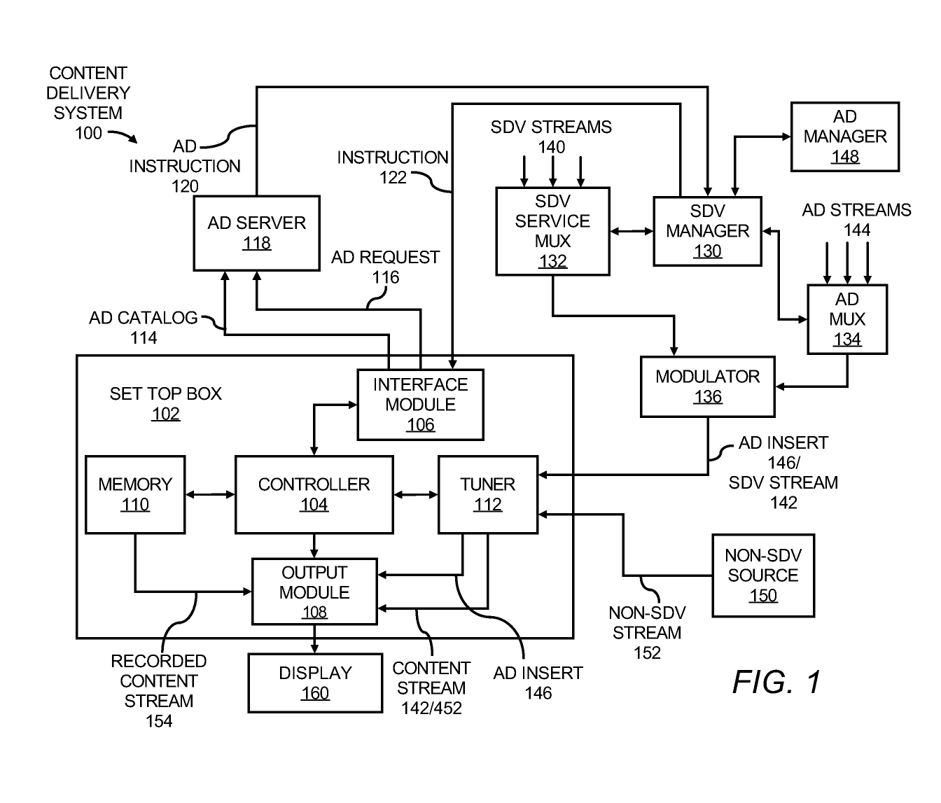

With reference first to FIG. 1, there is shown a block diagram of a content delivery system 100, according to an embodiment. It should be understood that the content delivery system 100 depicted in FIG. 1 may include additional components and that some of the components described herein may be removed and/or modified without departing from a scope of the content delivery system 100.

As depicted in FIG. 1, the content delivery system 100 includes a set top box (STB) 102, an ad server 118, a switched digital video (SDV) manager 130, a SDV service multiplexer 132, an ad multiplexer 134, a modulator 136, a non-SDV source 150, and a display 160. The STB 102 is also depicted as including a controller 104, an interface module 106, an output module 108, a memory 110, and a tuner 112. The STB 102 may comprise a digital video recorder (DVR) or personal video recorder (PVR) configured to store SDV streams 142 received from the SDV manager 130 and non-SDV streams 152 received from the non-STB source 150, which may comprise, for instance, a local television broadcast source. The modules 106-108 may comprise software modules, hardware modules, or a combination of software and hardware modules. Thus, in one embodiment, one or more of the modules 106-108 comprise circuit components. In another embodiment, one or more of the modules 106-108 comprise software code stored on a computer readable storage medium, which is executable by a processor.

The controller 104 is configured to perform various functions in the STB 102. In this regard, the controller 104 may comprise a microprocessor, a micro-controller, an application specific integrated circuit (ASIC), and the like, configured to perform various processing functions. In addition, or alternatively, the controller 104 may comprise software stored on a computer readable storage medium that may be executed by a computer processor.

One of the functions that the controller 104 is configured to perform is to control the STB 102 components to play a content stream, which includes the SDV stream 142 and the non-SDV stream 152. More particularly, the controller 104 is configured to route requests for the STB 102 and directs interaction with external devices through the interface module 106, the tuner 112, and the output module 108. Thus, for instance, the controller 104 is configured to control the tuner 112 to tune to particular SDV streams 142 or non-SDV streams 152. In this regard, the content stream 142/152 outputted through the output module 108 may be a live SDV stream 142 or a live non-SDV stream 152 received at the tuner 112 from a source, such as, one or more content providers, for instance, via a satellite or terrestrial broadcast from the content providers.

In another instance, the controller 104 is configured to control recording to the memory 110 and/or playback from the memory 110 of recorded content streams 154 received from the sources 130, 150. The memory 110 may thus be implemented as a DVR, PVR, or the like. As such, the memory 110 comprises a device configured to read from and write to media, such as, a floppy disk, a CD-ROM, a DVD-ROM, or other optical or magnetic media.

In either instance, the controller 104 is configured to cause the content stream 142/152 and the recorded content stream 154 to be outputted from the STB 102 through the output module 108 to a display 160, either from the memory 110 or in a relatively live manner as the content stream 142/152 is received through the tuner 112. The controller 104 may alternatively control the output module 108 to output the content stream 142/152 and the recorded content stream 154 to another output device, such as, another STB, a recording device, a computer system, etc.

According to an embodiment, the controller 104 is configured to detect an ad marker in the recorded content indicating an ad opportunity in the recorded content to thus enable a default advertisement to be replaced with an alternative advertisement. Thus, for instance, the controller 104 may process the recorded content as the recorded content is being outputted through the output module 108 to identify the ad marker. Alternatively, the controller 104 may process the recorded content as the content, which may originate as an SDV stream 142 or as a regular broadcast (non-SDV) stream 152, is being stored in the memory 110 or after the content has been stored in the memory 110.

The controller 104 is configured to process the content stored in the memory 110 to generate an ad catalog 114, which may include various information that the ad server 118 may employ in determining which alternative advertisement(s) are suitable for insertion into the recorded content stream 142/152 to replace one or more default advertisements. The controller 104 may process the content stored in the memory 110, for instance, by determining various information pertaining to the content, such as, the date on which the content was stored, the date on which the content first aired, the length of the ad opportunity in the content, demographic information pertaining to the STB 102, etc.

In addition, the controller 104 is configured to send an ad request 116 to the ad server 118 in order to initiate a process of inserting the alternative advertisement(s) during playback of the recorded content stream 154. The controller 104 may automatically send the ad catalog 114 to the ad server 118 with the ad request 116 or the controller 104 may send the ad catalog 114 to the ad server 118 in response to receipt of a query from the ad server 118. In any event, the ad catalog 114 may include, for instance, identification of the default advertisement, the length of the upcoming ad pod, the timing of the upcoming ad opportunity, demographic information of the STB 102 user, authorization to replace the default advertisement, previous advertisements that have been communicated to the STB 102 user, etc. In addition, the controller 104 may encrypt the information prior to sending the information to the ad server 118.

In response to receipt of the ad catalog 114 and the ad request 116, the ad server 118 is operable to determine whether one or more suitable alternative advertisements for the upcoming ad opportunity in the recorded content are available. If the ad server 118 determines that a suitable alternative advertisement(s) is available, the ad server 118 is configured to send an ad instruction 120 to the SDV manager 130 to retrieve the selected alternative advertisement(s). The ad server 118 may select the alternative advertisement(s) based upon the information contained in the ad catalog 114 through implementation of any suitable process known to those skilled in the art. For instance, the ad server 118 may select one or more alternative advertisements based upon the lengths of the alternative advertisements, previously communicated alternative advertisements, the demographics of the STB 102 user, etc. In addition, the ad server 118 may select multiple alternative advertisements in instances where the ad pod is of sufficient length for the multiple alternative advertisements to be inserted.

The ad instruction 120 may include an IP address from which the SDV manager 130 may obtain a copy of the alternative advertisement(s). More particularly, for instance, the SDV manager 130 may have access to multiple ad streams 144 through an ad multiplexer 134 and may connect to one or more of the multiple ad streams 144 to obtain copies of the one or more alternative advertisements selected by the ad server 118 for insertion into the recorded content stream 154 by the STB 102. According to another embodiment, the ad multiplexer 134 begins receipt of the ad stream 144 containing the selected alternative advertisement(s) upon receiving an instruction from the SDV manager 130.

In any regard, the SDV manager 130 is configured to complete the process of obtaining the alternative advertisement(s) in time for the alternative advertisement(s) to be inserted at the ad opportunity in the recorded content stream 154. In addition, an ad manager 148 may store a copy of the selected alternative advertisement(s) such that the SDV manager 130 may access the ad manager 148 to cause the alternative advertisement(s) to be streamed to the STB 102 at the appropriate times. The SDV manager 130 may determine when the selected alternative advertisement(s) is to be communicated to the STB 102 based upon information contained in the ad instruction 120 or the SDV manager 130 may receive this information directly from the controller 104.

At the correct time, such as, at the beginning of the ad opportunity, the SDV manager 130 is configured to begin streaming an ad insert 146 containing the selected alternative advertisement(s) on, for instance, a particular channel or IP address to the STB 102 through the modulator 136. In addition, the SDV manager 130 may send an instruction 122 to the controller 104 to tune or otherwise connect to the particular channel or IP address at the beginning of the ad opportunity in the playback of the recorded content stream 154. At other instances, the SDV manager 130 may be configured to access to multiple SDV streams 140 through an SDV service multiplexer 132 and may connect to one or more of the multiple SDV streams 140 to direct selected ones of the SDV streams 140 to be streamed to the STB 102 through the modulator 136.

Thus, the controller 104 is configured to cause the alternative advertisement(s) contained in the ad insert 146 to be played instead of the default advertisement(s) during play of the recorded content stream 154. In addition, at the end of the ad opportunity, the SDV manager 130 may communicate an instruction to the controller 104 to return to playing the recorded content stream 154. This instruction may, however, be communicated to the controller 104 with the initial instruction to tune to or connect to a particular channel or IP address to receive the alternative advertisement(s). Thus, for instance, the initial instruction may include an instruction for the controller 104 to tune to or connect to a particular channel or IP address for a length of time equivalent to the ad pod. In any regard, stale or untargeted advertisements may be replaced with fresher and/or targeted advertisements, which may have greater effectiveness on the STB 102 user.

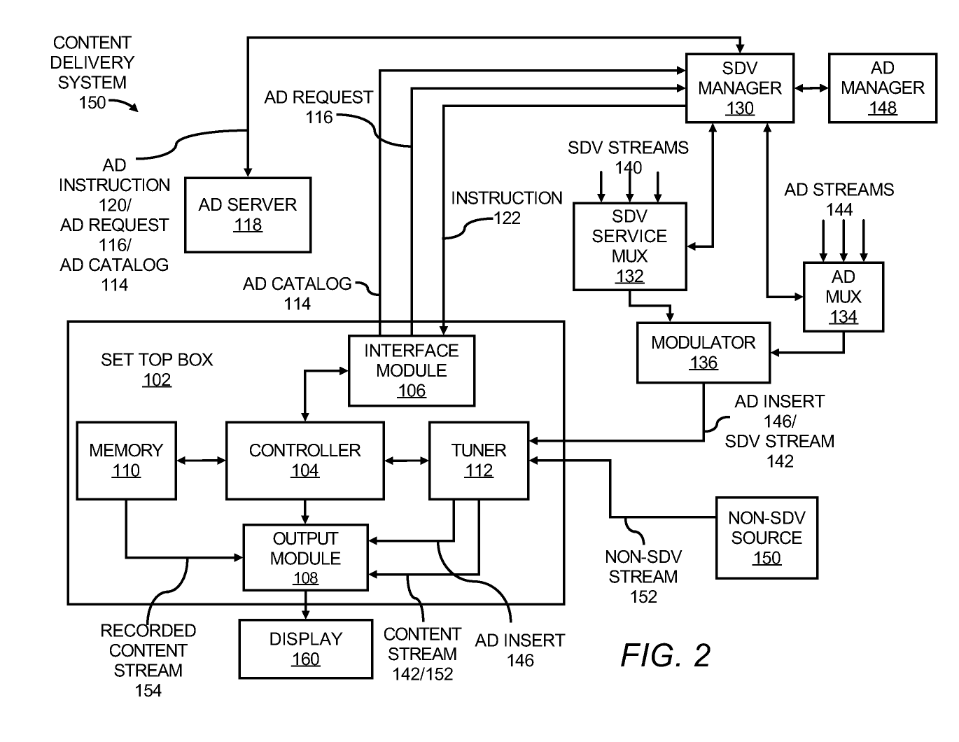

With reference now to FIG. 2, there is shown a block diagram of a content delivery system 150, according to another embodiment. It should be understood that the content delivery system 150 depicted in FIG. 2 may include additional components and that some of the components described herein may be removed and/or modified without departing from a scope of the content delivery system 150.

The content delivery system 150 depicted in FIG. 2 includes all of the same elements as the content delivery system 100 depicted in FIG. 1. As such, a detailed discussion of the common elements will not be repeated with respect to the content delivery system 150. Instead, only those features that differ from the content delivery system 100 will be discussed with respect to the content delivery system 150.

One distinction between FIG. 1 and FIG. 2 is that instead of communicating the ad request 116 and the ad catalog 114 to the ad server 118 as in FIG. 1, the controller 104 is configured to communicate the ad request 116 and the ad catalog to the SDV manager 130. In addition, the SDV manager 130 is configured to send the ad request 116 and the ad catalog 114 to the ad server 118. Further, the SDV manager 130 is configured to receive an ad instruction 120 from the ad server 118 and to retrieve one or more of the selected alternative advertisements as discussed above with respect to FIG. 1. As such, the STB 102 in the arrangement depicted in the content delivery system 150 depicted in FIG. 2 need not be in communication with the ad server 118.

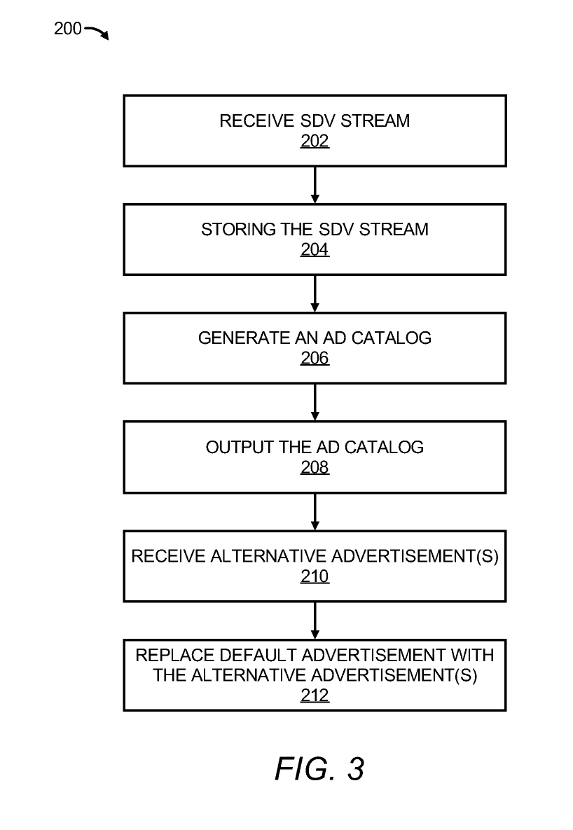

Turning now to FIG. 3, there is shown a flow diagram of a method 200 of playing an alternative advertisement in a set top box (STB) 102, according to an embodiment of the invention. It should be understood that the method 200 depicted in FIG. 3 may include additional steps and that some of the steps described herein may be removed and/or modified without departing from a scope of the method 200.

At step 202, the STB 102 receives a content stream 142/152 from a content source, such as, the SDV manager 130 or the non-SDV source 150. The content stream 142/152 includes content and at least one default advertisement. Depending, for instance, upon a user's instructions, the controller 104 is configured to one or both of cause the content stream 142/152 to be played as a live stream and cause the content stream 142/152 to be stored in the memory 110.

At step 204, however, the controller 104 causes the content stream 142/152 to be stored in the memory 110. As such, the memory 110 comprises a DVR, PVR, etc.

At step 206, the controller 104 generates an ad catalog 114 pertaining to the stored content stream 142/152. As discussed above, the controller 104 generates the ad catalog 114 from information pertaining to the stored content stream 142/152, such as, timing and date information, demographic information, etc., which may be contained in an ad marker of the content stream 142/152. In addition, the controller 104 may generate the ad catalog 114 substantially immediately after the content stream 142/152 has been stored in the memory 110, after a predetermined period of time following storage of the content stream 142/152, in response to a request from a user to play the stored content stream 154, etc.

The ad marker may contain information regarding an upcoming ad opportunity, for instance, the position of the ad opportunity in relation to the content stream 142/152, the duration of the ad opportunity, identification information of the default advertisement to be played during the ad opportunity, etc. In addition, the controller 104 may generate the ad catalog 114 to include information useable by an ad server in identifying one or more alternative advertisements to be played by the STB 102 during play of the recorded content stream 154 in place of the default advertisement, as discussed in greater detail herein above.

At step 208, the controller 104 outputs the ad catalog 114 to at least one of the ad server 118 and the SDV manager 130. The controller 104 may output the ad catalog 114 along with an ad request 116 or separately from the ad request 116. In any respect, the ad server 118 is configured to receive the ad catalog 114 and to select the alternative advertisement(s) for the STB 102, for instance, using the information contained in the ad catalog 114. In addition, the ad server 118 is configured to send an ad instruction 120 to the SDV manager 130, in which the ad instruction 120 contains information pertaining to the alternative advertisement and may also contain information pertaining to the position of the ad opportunity in the recorded content stream 154. The SDV manager 130 may alternatively receive the ad opportunity information directly from the STB 102, as discussed above with respect to FIG. 2.

In any regard, The SDV manager 130 is configured to obtain the selected alternative advertisement(s) using the ad instruction 120. For instance, the ad instruction 120 may include an IP address from which the SDV manager 130 may obtain a copy of the alternative advertisement(s). More particularly, for instance, the SDV manager 130 may be configured to have access to multiple ad streams 144 through an ad multiplexer 134 and may connect to one or more of the multiple ad streams 144 to obtain copies of the one or more alternative advertisements selected by the ad server 118 for insertion into the recorded content stream 154 by the STB 102.

In any event, the SDV manager 130 is configured to send an ad insert 146 containing the alternative advertisement to the STB 102. The SDV manager 130 may communicate the ad insert 146 to a selected channel (or equivalently, IP address). In addition, the SDV manager 130 is configured to communicate an instruction to the STB 102 to tune to the selected channel (or IP address) at the correct time for the alternative advertisement to be played during the ad opportunity.

At step 210, the STB 102 receives the alternative advertisement(s) from the SDV manager 130. By way of example, the controller 104 operates the tuner 112 to tune to the selected channel upon which the SDV manager 130 has communicated the ad insert 146 containing the alternative advertisement(s). In addition, at step 212, the controller 104 controls the output module 108 to output the alternative advertisement(s) contained in the ad insert 146 received from the SDV manager 130 in place of the default advertisement contained in a recorded content stream 154.

Following receipt of the alternative advertisement(s), the controller 104 may receive an instruction from the SDV manager 130 to resume play of the recorded content stream 154 following the conclusion of the ad opportunity. This instruction may be communicated at step 210 or the instruction may be communicated immediately before the alternative advertisement has concluded.

Some or all of the operations set forth in the figures may be contained as a utility, program, or subprogram, in any desired computer readable storage medium. In addition, the operations may be embodied by computer programs, which can exist in a variety of forms both active and inactive. For example, they may exist as software program(s) comprised of program instructions in source code, object code, executable code or other formats. Any of the above may be embodied on a computer readable storage medium, which include storage devices.

Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

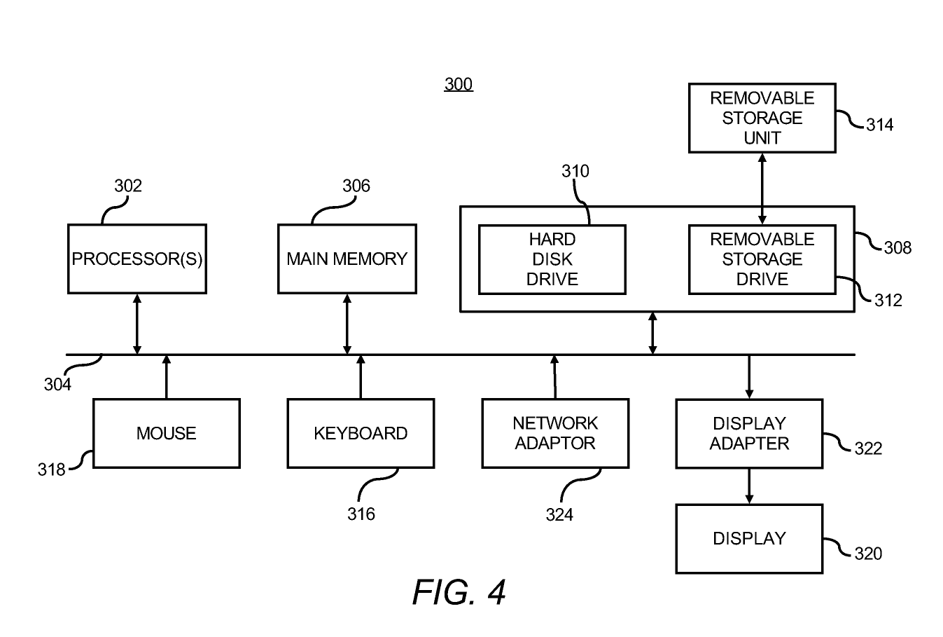

FIG. 4 illustrates a block diagram of a computing apparatus 300 configured to implement or execute one or more of the processes depicted in FIGS. 1-3, according to an embodiment. It should be understood that the illustration of the computing apparatus 300 is a generalized illustration and that the computing apparatus 300 may include additional components and that some of the components described may be removed and/or modified without departing from a scope of the computing apparatus 300. According to an embodiment, the computing apparatus 300 comprises the set top box 102 depicted in FIGS. 1 and 2.

The computing apparatus 300 includes a processor 302 that may implement or execute some or all of the steps described in one or more of the processes depicted in FIGS. 1A, 1B, and 2. Commands and data from the processor 302 are communicated over a communication bus 304. The computing apparatus 300 also includes a main memory 306, such as a random access memory (RAM), where the program code for the processor 302, may be executed during runtime, and a secondary memory 308. The secondary memory 308 includes, for example, one or more hard disk drives 310 and/or a removable storage drive 312, representing a floppy diskette drive, a magnetic tape drive, a compact disk drive, etc., where a copy of the program code for one or more of the processes depicted in FIGS. 1-3 may be stored.

The removable storage drive 310 reads from and/or writes to a removable storage unit 314 in a well-known manner. User input and output devices may include a keyboard 316, a mouse 318, and a display 320. A display adaptor 322 may interface with the communication bus 304 and the display 320 and may receive display data from the processor 302 and convert the display data into display commands for the display 320. In addition, the processor(s) 302 may communicate over a network, for instance, the Internet, LAN, etc., through a network adaptor 324.

It will be apparent to one of ordinary skill in the art that other known electronic components may be added or substituted in the computing apparatus 300. It should also be apparent that one or more of the components depicted in FIG. 3 may be optional (for instance, user input devices, secondary memory, etc.).

Through implementation of the set top box and method disclosed herein, stale or otherwise old advertisements that have been recorded to a digital video recorder (DVR) of the set top box along with regular content may be replaced with fresher or otherwise newer advertisements. In addition or alternatively, the default content communicated with the regular content may be replaced with targeted advertisements for the set top box user. Moreover, the same content stored on the DVR may be played back at different times with different alternative advertisements replacing the default advertisements each time the stored content is played.

What has been described and illustrated herein is an embodiment along with some of its variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A set top box comprising:
a tuner for receiving a content stream from a content source, said content stream containing content and a default advertisement;
a memory for storing the content stream; and
a controller for generating and outputting an ad catalog to at least one of an ad server and an SDV manager, wherein the ad catalog contains information useable by the ad server in identifying one or more alternative advertisements to be played by the set top box during play of the content stream stored in the memory in place of the default advertisement, and wherein the controller is configured to receive the one or more alternative advertisements and to replace the default advertisement in the stored content stream with the one or more alternative advertisements during play of the stored content stream.

2. The set top box according to claim 1, wherein the controller is further configured to generate the ad catalog for the content stream stored in the memory prior to playback of the stored content stream.

3. The set top box according to claim 1, wherein the controller is further configured to generate the ad catalog for a stored content stream one of following a predetermined period of time following storage of the content stream and during playback of the stored content stream.

4. The set top box according to claim 1, further comprising an interface module configured to enable communications between the controller and at least one of the ad server and the SDV manager.

5. The set top box according to claim 1, wherein the ad catalog includes at least one of identification of the default advertisement, length of an ad pod containing the default advertisement, timing of an upcoming ad opportunity, demographic information of user of the set top box, authorization to replace the default advertisement, previous alternative advertisements that have been communicated to the set top box.

6. The set top box according to claim 1, wherein the SDV manager is configured to communicate the one or more alternative advertisements through a modulator to the set top box at a selected channel and wherein the controller is configured to operate the tuner to tune to the selected channel to receive the one or more alternative advertisements during playback of the stored content stream.

7. The set top box according to claim 6, wherein the controller is configured to tune to the selected channel immediately prior to playing of the stored default advertisement from the memory to cause the one or more alternative advertisements to be played in place of the default advertisement.

8. The set top box according to claim 7, wherein the controller is further configured to receive an instruction from the SDV manager to resume play of the recorded content stream following play of the one or more alternative advertisements.

9. The set top box according to claim 1, wherein the set top box comprises a digital video recorder.

10. A method of playing an alternative advertisement in a set top box (STB), said method comprising:
storing a content stream from a content source, said content stream containing content and a default advertisement;
generating an ad catalog containing information useable by an ad server in identifying one or more alternative advertisements to be played by the set top box in place of the default advertisement contained in the stored content stream;
outputting the ad catalog to at least one of the ad server and an SDV manager, wherein the ad server is configured to identify one or more alternative advertisements to replace the stored default advertisement;
receiving the identified one or more alternative advertisements; and
replacing the default advertisement with the identified one or more alternative advertisements during playback of the stored content stream.

11. The method according to claim 10, wherein receiving the identified one or more alternative advertisements further comprises tuning to a selected channel on which the SDV manager is configured to communicate the one or more alternative advertisements to the STB.

12. The method according to claim 11, wherein tuning to the selected channel further comprises tuning to the selected channel immediately prior to playing of the default advertisement from a memory to cause the one or more alternative advertisements to be played in place of the default advertisement.

13. The method according to claim 12, further comprising:
receiving an instruction from the SDV manager to resume play of the stored content stream following play of the one or more alternative advertisements.

14. The method according to claim 10, wherein generating the ad catalog further comprises generating the ad catalog for the stored content stream prior to playback of the stored content stream.

15. The method according to claim 10, wherein generating the ad catalog for the stored content stream one of following a predetermined period of time following storage of the content stream and during playback of the stored content stream.

16. The method according to claim 10, wherein generating the ad catalog further comprises generating the ad catalog to contain information pertaining to at least one of identification of a default advertisement to be replaced with the alternative advertisement, a length of the default advertisement, a timing of when the default advertisement is to start, identifications of prior advertisements played by the STB, and demographic information of a user of the STB.

17. A computer readable storage medium on which is embedded one or more computer programs, said one or more computer programs implementing a method of playing an alternative advertisement in a set top box (STB), said one or more computer programs comprising a set of instructions for:
storing a content stream from a content source, said content stream containing content and a default advertisement;
generating an ad catalog containing information useable by an ad server in identifying one or more alternative advertisements to be played by the set top box in place of a default advertisement contained in the stored content stream;
outputting the ad catalog to at least one of the ad server and an SDV manager, wherein the ad server is configured to identify one or more alternative advertisements to replace the stored default advertisement;
receiving the identified one or more alternative advertisements; and
replacing the default advertisement with the identified one or more alternative advertisements during playback of the stored content stream.

18. The computer readable storage medium according to claim 17, said one or more computer programs comprising a further set of instructions for:
tuning to a selected channel on which the SDV manager is configured to communicate the one or more alternative advertisements to the STB.

19. The computer readable storage medium according to claim 17, said one or more computer programs comprising a further set of instructions for:
receiving an instruction from the SDV manager to resume play of the stored content stream following play of the one or more alternative advertisements.

20. The computer readable storage medium according to claim 17, said one or more computer programs comprising a further set of instructions for:
generating the ad catalog for the stored content stream following a predetermined period of time following storage of the content stream.
